(19) United States
(12) Patent Application Publication
(10) Pub. No.: US 2009/0157827 A1
(43) Pub. Date: Jun. 18, 2009

(54) System and method for generating response email templates

(76) Inventor: Srinivas Bangalore, Morristown, NJ (US)

Correspondence Address: AT & T Legal Department - WS;Attn: Patent Docketing, Room 2A-207, One AT & T Way, Bedminster, NJ, 07921, US

(21) Appl. No.: 12/002,103

(22) Filed: Dec. 14, 2007

(51) Int. Cl. G06F 15/16

(52) U.S. Cl. 709/206

(57) ABSTRACT

Disclosed is a method and system for generating a response email template from previously transmitted response emails for use in responding more efficiently to a client email. The response email template is generated by identifying text strings common to the transmitted response emails and creating the template from at least some of the text strings.

### BACKGROUND OF THE INVENTION

The present invention is generally directed to email, and more particularly to generating templates for use in responding to emails.

Each year, companies typically receive millions of emails from customers and consumers. Agents of a company are responsible for responding to these emails. Responding to the emails appropriately is often a time-consuming endeavor. In particular, agents have to respond to the email in a suitable fashion, such as attempting to resolve a customer's query or complaint. Due to the large number of emails received, the aggregate time needed to respond to the emails is typically long and grows with each additional email.

One technique used by companies to speed up the time needed by an agent to respond to an email is by the use of response email templates. A response email template is an electronic file having an outline of a response to an email. An agent modifies a template to generate a specific response to an email.

There are typically many possible response email templates from which to choose for any given email. As a result, a computer may suggest a template to an agent for use in responding to a particular email. This may occur from the classification of a received email. Specifically, when a company receives an email from a customer, the email may be classified into a category based on the email's contents or subject line. A predetermined template for a given classification can then be provided to the agent for use in responding to the email. For example, all emails dealing with incorrect bill amounts may be responded to in a similar fashion using the same response email template.

As the number of classifications increase, however, the number of templates needed also increases. Furthermore, the template(s) for a given classification may not be directly applicable to a specific email. As a result, the agent may have to reply to the email without using a template. This increases the time needed to respond to the email. Additionally, as the number of templates available increases, the selection of an applicable template becomes more difficult and time consuming, thereby again increasing the time needed to respond to the email.

There remains a need to reduce the time needed to respond to received emails.

### BRIEF SUMMARY OF THE INVENTION

In accordance with an embodiment of the present invention, a response email template is generated from previously transmitted response emails. The response email template is generated by identifying text strings common to the transmitted response emails and creating the template from at least some of the text strings. The text strings may include one or more words, one or more sentences, or one or more paragraphs.

In one embodiment, identifying text strings includes identifying word matches between a pair of previously transmitted emails. The word matches are extracted from the pair of previously transmitted emails. The identifying and extracting steps are repeated for each additional pair of response emails. The response email template can then be generated from text strings occurring a predetermined number of times.

In one embodiment, the response emails are normalized. This normalization can occur by changing (e.g., performing an insertion, deletion, or replacement of) at least one text string in the response emails that is not particularly relevant to the content of the email. For example, names, dates, etc. can be changed to a generic word (e.g., the phrase “Sincerely John” can be changed to “Sincerely Name”) in order to remove these differences between emails. Once a response email template is generated, a customer's email can be responded to by revising the response email template appropriately.

These and other advantages of the invention will be apparent to those of ordinary skill in the art by reference to the following detailed description and the accompanying drawings.

### BRIEF DESCRIPTION OF THE DRAWINGS

FIG. 1 is a block diagram of a system having a first client, a second client, and a third client in communication with a server having a template generation module in accordance with an embodiment of the present invention;

FIGS. 2A and 2B are flowcharts illustrating the steps performed by the template generation module to generate a response email template;

FIG. 3 is another flowchart illustrating the steps performed by the template generation module to generate a response email template; and

FIG. 4 is a high level block diagram of a computer in accordance with an embodiment of the present invention.

### DETAILED DESCRIPTION

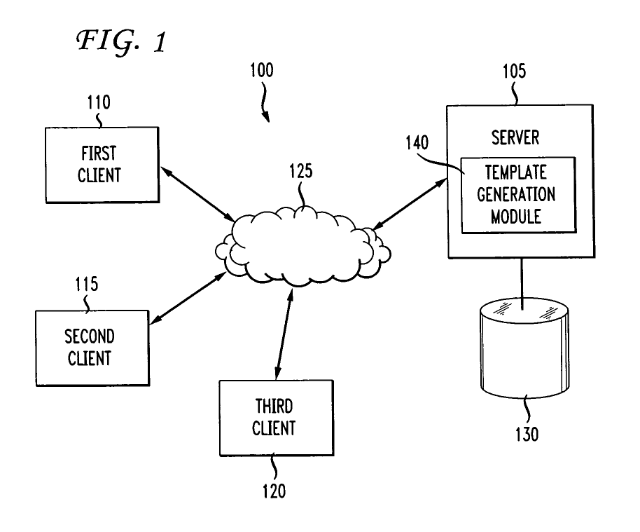

FIG. 1 shows a block diagram of a system 100 including a server 105 in communication with a first client 110, a second client 115, and a third client 120 over a network 125 such as the Internet.

The server 105 receives a plurality of emails from the clients 110, 1 15, 120. The server 105 may be a server of a company. One or more agents of the company respond to the one or more emails received from the clients 110, 115, 120. In one embodiment, emails received from the clients 110, 115, and 120 (referred to herein as client emails) and corresponding email responses (referred to herein as response emails) are stored in a database 130.

The server 105 includes a template generation module 140. The template generation module 140 generates response email templates from previously transmitted response emails. The templates are used by agents in preparing response emails to current client emails. In particular, assume that similar client emails are responded to with similar replies. If the commonalities of the replies are detected and stored as templates, then a new email that is similar to the previous emails might be responded to using a template.

The template generation module 140 identifies text strings common to previously transmitted response emails. In one embodiment, the template generation module 140 uses a longest common substring algorithm to determine the commonalities between response emails. The text strings are one or more words, one or more sentences, or one or more paragraphs in the response emails. The template generation module 140 creates a response email template from at least some of the text strings. The template generation module 140 may be implemented in hardware, software, or a combination of hardware and software.

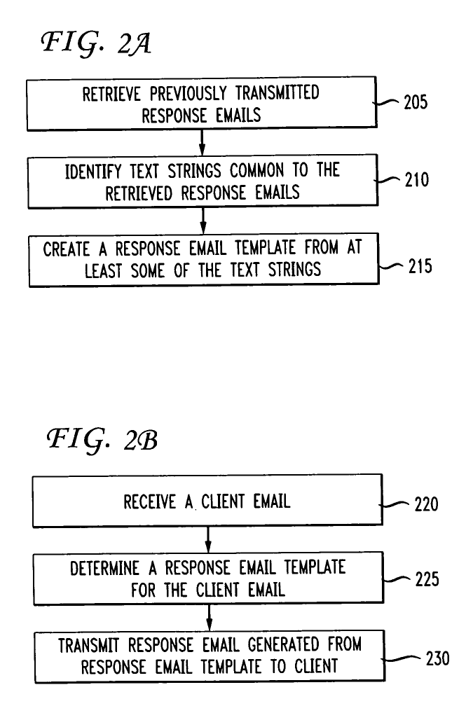

FIGS. 2A and 2B are flowcharts showing the algorithm used by the template generation module 140 to generate a response email template. The template generation module 140 retrieves (e.g., from database 130) previously transmitted response emails in step 205. The template generation module 140 then identifies text strings common to the retrieved response emails in step 210. In one embodiment, text strings common to the retrieved response emails are text strings that occur a predetermined number of times in the response emails (e.g., a sentence occurring in seventy-five out of one hundred response emails). Step 210 may be performed on a predetermined number of response emails (e.g., a pair of response emails) in the set of retrieved response emails or on all of the response emails retrieved in step 205. In step 215, the template generation module 140 generates a response email template from at least some of the text strings that are common to the response emails. In particular, after the text strings common to the retrieved response emails are identified, the text strings are extracted from the response emails. When the text strings are extracted, they are removed from the response emails and copied to another electronic file (i.e., the response email template).

When the server 105 receives a client email (e.g., from the first client 110) in step 220 of FIG. 2B, the server 105 then determines a response email template for the client email (step 225). This determination may be made by a machine learning program that is trained to associate client emails with templates based on past associations between agents' selection of templates and client emails. The server 105 then provides an agent using the server 105 with the response email template. The agent creates a response email for the client email by modifying (e.g., inserting, substituting, or deleting) text in the response email template. The response email is then transmitted to the client in step 230.

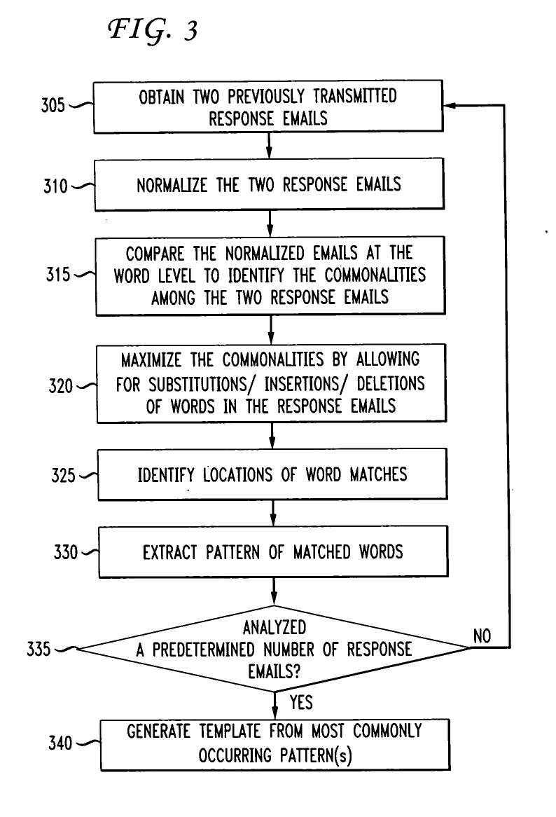

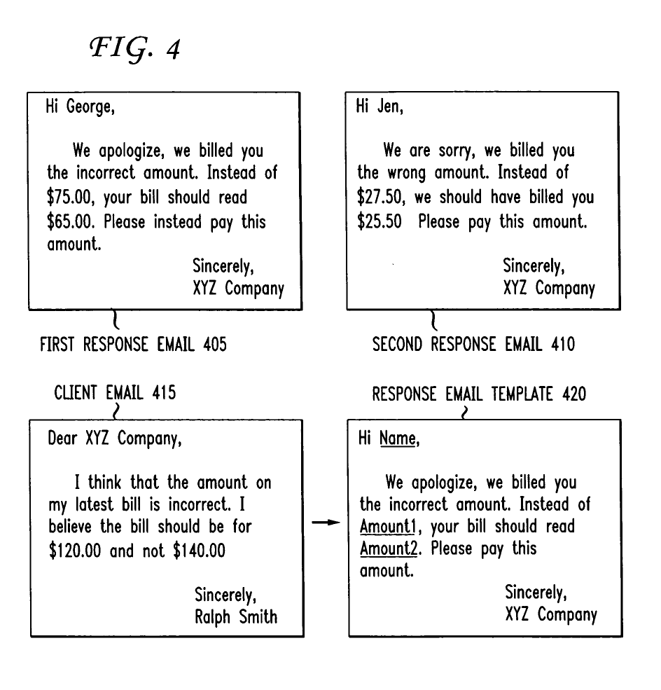

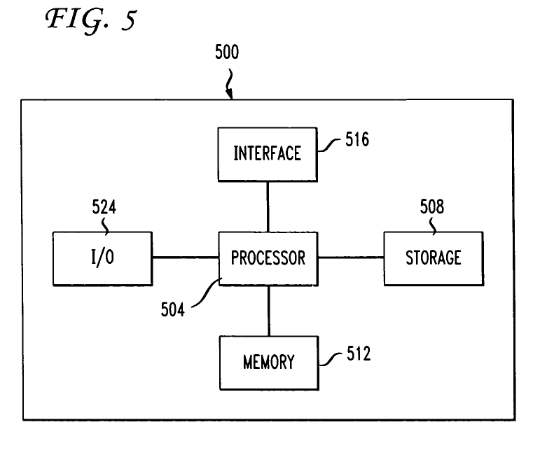

FIG. 3 shows a flowchart of another embodiment of the steps performed by the template generation module 140 to generate a response email template. FIG. 4 shows an example of a pair of stored response emails (i.e., first response email 405 and second response email 410) and one client email 415. The flowchart of FIG. 3 is described below with respect to the example emails shown in FIG. 4.

The template generation module 140 obtains, in step 305, the two response emails 405, 410 (e.g., from the database 130). The template generation module 140 normalizes the two response emails in step 310. In one embodiment, the two emails are normalized by replacing certain variations in the two emails, such as names of customers, dates, service names, billing amount, etc., with a generic word or phrase.

For example, the template generation module 140 determines that “George” and “Jen” differ in the two response emails 405, 410 but represent the same thing—a name. As a result, the template generation module 140 can replace the two names—George and Jen—with a generic phrase, such as Name. Further examples of normalization of the two response emails 405, 410 include replacing the billing amounts (e.g., $75.00, $65.00, $27.50, and $25.50) with a generic phrase such as Amount.

In step 315, the template generation module 140 compares the normalized response emails at the word level to identify the commonalities among the two response emails 405, 410. The commonalities are maximized in step 320 by allowing for substitutions, insertions, and/or deletions of words in one or both of the response emails. For example, the phrase “We apologize” in the first response email 405 has the same meaning as “We are sorry” in the second response email 410 and one phrase can be replaced by the other phrase to maximize the commonalities between the two response emails 405, 410.

The cost of an error (substitution, insertion, and/or deletion) can be adjusted according to domain knowledge. Generally, a substitution, insertion, or deletion error is penalized equally. However, not all words and sentences have the same impact on the meaning of the response. An embodiment of the invention has the flexibility to weight changes to sentences differently based on the sentence's impact on the meaning of the response. For example, the deletion of legal statements in the response can be made prohibitively expensive while errors in the salutations part of the response might not be penalized as much. The locations of word matches in the pair of response emails are then identified in step 325. A pattern of matched words is extracted in step 330.

For example, suppose the template generation module 140 substitutes “We apologize” for “We are sorry” in the second response email 410. The template generation module 140 can then extract out this phrase (i.e., “We apologize”) from both response emails 405, 410. Similarly, the template generation module 140 can extract out “we billed you the incorrect amount,” after substituting “incorrect” for “wrong” in the second response email 410. The template generation module 140 can extract additional words or sentences out of the response emails 405, 410.

The template generation module 140 then determines whether a predetermined number of response emails have been analyzed. If not, the process returns to step 305 and the process repeats for an additional pair of response emails. In one embodiment, analyzing additional pairs of response emails includes analyzing every combination of response emails. Thus, in this embodiment, one response email is compared with all of the remaining stored response emails. Once the one email has been compared with all of the other stored response emails, then this one email is updated with another response email. In this way, every possible combination of response emails are compared with each other.

If a predetermined number of response emails have been analyzed, then a response email template is generated in step 340 from the most commonly occurring pattern(s). For example, response email template 420 is generated from the response emails 405, 410 (assuming that, in this example, two response emails satisfy the predetermined number of response emails needed). In one embodiment, the template 420 includes several generic words, such as Name, Amount1, and Amount2, that need to be filled in by the agent when the agent determines to use template 420. The template can be stored in a memory of the server 105 for future use. This template can then be used by an agent to create a response email to client email 415.

In another embodiment, response emails can be analyzed as described above to create a response telephone call template. A response telephone call template can be read by an agent to answer one or more telephone calls received from customers. For example, the response emails can be analyzed to determine frequently asked questions by customers and then a response telephone call template can be created to respond to these frequently asked questions. In one embodiment, the extracted response telephone call template can be used in an IVR application. As a result, in one embodiment a human operator can be bypassed.

FIG. 5 shows a high level block diagram of a computer 500 which may be used to implement the template generation module 140. The computer 500 can, for example, perform the steps described above (e.g., with respect to FIGS. 2A, 2B and/or FIG. 3). Computer 500 contains a processor 504 which controls the overall operation of the computer by executing computer program instructions which define such operation. The computer program instructions may be stored in a storage device 508 (e.g., magnetic disk, database) and loaded into memory 512 when execution of the computer program instructions is desired. Thus, the computer operation will be defined by computer program instructions stored in memory 512 and/or storage 508 and the computer will be controlled by processor 504 executing the computer program instructions. Computer 500 also includes one or more interfaces 516 for communicating with other devices. Computer 500 also includes input/output 524 which represents devices which allow for user interaction with the computer 500 (e.g., display, keyboard, mouse, speakers, buttons, etc.). One skilled in the art will recognize that an implementation of an actual computer will contain other components as well, and that FIG. 5 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for generating a response email template from a plurality of previously transmitted response emails comprising:
identifying text strings common to said plurality of previously transmitted response emails; and
creating a response email template from at least some of said text strings.

2. The method of claim 1 wherein said identifying said text strings comprises identifying at least one of a word, a plurality of words, a sentence, a plurality of sentences, a paragraph, and a plurality of paragraphs.

3. The method of claim 1 further comprising extracting said text strings from said plurality of previously transmitted response emails.

4. The method of claim 1 wherein said identifying text strings common to said plurality of previously transmitted response emails further comprises identifying word matches between a pair of said previously transmitted response emails.

5. The method of claim 4 further comprising extracting said word matches from said pair of said previously transmitted response emails.

6. The method of claim 5 further comprising repeating said identifying step and said extracting step for each additional pair of said previously transmitted response emails.

7. The method of claim 1 wherein said creating step further comprises creating said response email template from text strings occurring a predetermined number of times in said plurality of previously transmitted response emails.

8. The method of claim 1 further comprising storing said response email template in a memory.

9. The method of claim 1 further comprising normalizing the plurality of previously transmitted response emails.

10. The method of claim 9 wherein said normalizing step further comprises changing at least one text string in said plurality of previously transmitted response emails.

11. The method of claim 1 further comprising responding to an email using said response email template.

12. An apparatus for generating a response email template from a plurality of previously transmitted response emails comprising:
means for identifying text strings common to said plurality of previously transmitted response emails; and
means for creating a response email template from at least some of said text strings.

13. The apparatus of claim 12 wherein said means for identifying said text strings comprises means for identifying at least one of a word, a plurality of words, a sentence, a plurality of sentences, a paragraph, and a plurality of paragraphs.

14. The apparatus of claim 12 further comprising means for extracting said text strings from said plurality of previously transmitted response emails.

15. The apparatus of claim 12 wherein said means for identifying text strings common to said plurality of previously transmitted response emails further comprises means for identifying word matches between a pair of said previously transmitted response emails.

16. The apparatus of claim 15 further comprising means for extracting said word matches from said pair of said previously transmitted response emails.

17. The apparatus of claim 12 wherein said means for creating further comprises means for creating said response email template from text strings occurring a predetermined number of times in said plurality of previously transmitted response emails.

18. The apparatus of claim 12 further comprising means for storing said response email template.

19. The apparatus of claim 12 further comprising means for normalizing the plurality of previously transmitted response emails.

20. The apparatus of claim 19 wherein said means for normalizing further comprises means for changing at least one text string in said plurality of previously transmitted response emails.

21. The apparatus of claim 12 further comprising means for responding to an email using said response email template.

22. A computer readable medium comprising computer program instructions capable of being executed in a processor and defining the steps comprising:
identifying text strings common to said plurality of previously transmitted response emails; and
creating a response email template from at least some of said text strings.

23. The computer readable medium of claim 22 wherein said step of identifying said text strings comprises identifying at least one of a word, a plurality of words, a sentence, a plurality of sentences, a paragraph, and a plurality of paragraphs.

24. The computer readable medium of claim 22 further comprising the step of extracting said text strings from said plurality of previously transmitted response emails.

25. The computer readable medium of claim 22 wherein said identifying text strings common to said plurality of previously transmitted response emails further comprises identifying word matches between a pair of said previously transmitted response emails.

26. The computer readable medium of claim 25 further comprising the step of extracting said word matches from said pair of said previously transmitted response emails.

27. The computer readable medium of claim 26 further comprising repeating said identifying step and said extracting step for each additional pair of said previously transmitted response emails.

28. The computer readable medium of claim 22 wherein said creating step further comprises creating said response email template from text strings occurring a predetermined number of times in said plurality of previously transmitted response emails.

29. The computer readable medium of claim 22 further comprising the step of storing said response email template in a memory.

30. The computer readable medium of claim 22 further comprising the step of responding to an email using said response email template.

31. A method for generating a response telephone call template comprising:
identifying text strings common to a plurality of previously transmitted response emails; and
creating a response telephone call template from at least some of said text strings.

32. The method of claim 31 further comprising responding to a telephone call using said response telephone call template.

33. The method of claim 31 wherein said identifying said text strings comprises identifying frequently asked questions.

34. The method of claim 31 wherein said identifying said text strings comprises identifying at least one of a word, a plurality of words, a sentence, a plurality of sentences, a paragraph, and a plurality of paragraphs.

35. The method of claim 31 further comprising extracting said text strings from said plurality of previously transmitted response emails.
